(19) United States
(12) Patent Application Publication
(10) Pub. No.: US 2023/0390786 A1
(43) Pub. Date: Dec. 7, 2023

(54) COMMINUTION APPARATUS FOR COMMINUTING A SOLIDS-CONTAINING MEDIUM AND A METHOD FOR CONTROLLING A COMMINUTION APPARATUS

(71) Applicant: VOGELSANG GMBH & CO. KG, Essen (DE)

(72) Inventors: Torsten Burhorst, Essen (DE); Cord Lömker, Essen (DE)

(73) Assignee: VOGELSANG GMBH & CO. KG, Essen (DE)

(21) Appl. No.: 18/203,908

(22) Filed: May 31, 2023

(30) Foreign Application Priority Data
Jun. 1, 2022 (DE) 202022103106.1

(51) Int. Cl. B02C 18/10; B02C 25/00; B02C 18/24

(52) U.S. Cl. CPC B02C 18/10; B02C 25/00; B02C 18/24; B02C 2210/01

(57) ABSTRACT

A comminution apparatus for comminuting a solids-containing medium includes a rotatably mounted drive shaft, which can be coupled to a drive apparatus to drive a cutting apparatus, the cutting apparatus having a first cutting element, comprising a cutting edge, and a second cutting element, comprising a second cutting edge, wherein the first cutting element and the second cutting element are movable relative to one another in such a way that the relative movement brings about a shearing action between the cutting edge and the second cutting edge. The first cutting element is connected fixedly in terms of torque to the drive shaft and is movable on a first movement path relative to the second cutting element. The comminution apparatus is adapted for operation in a first operating mode and a second operating mode different from the first operating mode to comminute the solids-containing medium.

### CROSS-REFERENCE TO FOREIGN PRIORITY APPLICATION

The present application claims the benefit under 35 U.S.C. §§ 119(b), 119(e), 120, and/or 365(c) of German Application No. DE 20 2022 103106.1 filed Jun. 1, 2022.

### FIELD OF THE INVENTION

The invention relates to a comminution apparatus for comminuting a solids-containing medium, the comminution apparatus comprising a rotatably mounted drive shaft which can be coupled to a drive apparatus to drive a cutting apparatus, and the cutting apparatus, wherein the cutting apparatus has a first cutting element, comprising at least one first cutting edge, and a second cutting element, comprising at least one second cutting edge, wherein the first cutting element and the second cutting element are movable relative to one another in such a way that a relative movement of the first cutting element and of the second cutting element brings about a shearing action between the at least one first cutting edge and the at least one second cutting edge, wherein the at least first cutting element is connected fixedly in terms of torque to the drive shaft and is movable on a first movement path relative to the second cutting element.

The invention also relates to a method for controlling a comminution apparatus for comminuting a solids-containing medium, wherein the method comprises the step of starting the comminution apparatus.

### BACKGROUND OF THE INVENTION

It is known to protect hydraulic machines, for example pumps, by means of a screen from stones or metal parts, which may be present in a solids-containing medium, for example slurry or wastewater, that is to be delivered. However, this has the disadvantage that the screen clogs up, this preventing delivery of the hydraulic medium.

To solve this problem, it is known to use comminution apparatuses of the aforementioned construction, specifically to dispose them upstream of the pump in the flow direction, in order to comminute the solids-containing medium. These comminution apparatuses are used in particular in the form of what are referred to as wet comminutors, in order, for example in the field of the foodstuff industry, of biosuspensions for further provision of energy, or for other agricultural intended uses, to prepare fluid mixtures that are mixed through with solids and in the process to comminute the solids they contain. Comminution apparatuses are designed in particular to homogenize a solids-containing medium. For example, the comminution apparatus is designed to homogenize solids-containing media in the foodstuff industry or else for biogas plants.

Solids, solid masses, or solids-containing liquids are, for example, a solids-containing medium. A solids-containing medium is also in particular a liquid medium which contains fibres and/or foreign substances. A solids-containing medium is preferably a heterogeneous medium. A solids-containing medium may, for example, comprise organic and/or inorganic substances. In particular, the solids-containing medium may contain solids and a liquid medium, for example water or oils. In particular, a solids-containing medium may comprise fibres, for example hairs or industrial fibres, as solids.

A comminution apparatus is known, for example, from PCT/EP2011/065691, which is also published under EP 2 613 884 B1. This comminution apparatus comprises a first cutting element, comprising at least one first cutting edge, and a second cutting element, which is movable on a first movement path relative to the first cutting element and comprises at least one second cutting edge, wherein the second cutting element lies against the first cutting element in such a way that the relative movement of the second cutting element along the first movement path brings about a shearing action between the at least one first cutting edge and the at least one second cutting edge. This comminution apparatus also has an adjustment mechanism, which adjusts the second cutting element relative to the first cutting element on a second movement path in such a way that, in the event of wear of the first and/or second cutting element owing to the relative movement along the first movement path, the first cutting element is readjusted to permanently bear against the first cutting element, in order therefore to ensure a constant comminution performance of the comminution apparatus during operation—in this respect the comminution performance describes the ability of the comminution apparatus to comminute a solids-containing medium. The disclosure of this document, EP 2 613 884 B1, is incorporated by reference in its entirety in the disclosure of the present description.

A fundamental problem that arises in the case of comminution apparatuses of this construction is that they are designed for a constant comminution performance irrespective of the intended use. This comminution performance then usually at most meets the average requirements of a user, or else only a very specific requirement of the user. For example, a comminution apparatus can be set for an average comminution performance with a solids-containing medium. Similarly, comminution apparatuses can, however, also be set for a maximum comminution performance or for a comminution performance with a maximum throughflow rate of the solids-containing medium that is to be comminuted. It is for instance also conceivable for comminution apparatuses to be set in such a way that the solids-containing medium that is to be comminuted is comminuted with a comminution performance which consumes as little energy as possible.

In the case of the known comminution apparatuses, the user themselves does not have the option of adapting the comminution performance itself easily and quickly to their individual requirement profile. In practice, however, users set comminution apparatuses for a multiplicity of different applications. Depending on the application of the comminution apparatus, the requirements for the comminution performance vary. However, the requirement for as long as possible a service life of the comminution apparatus persists, generally irrespective of the use case. Therefore, when operating known comminution apparatuses, users must always make a compromise between comminution performance and wear or service life.

If, for example, the comminution apparatus is intended to serve merely to protect a pump disposed downstream in the flow direction of the solids-containing medium, a high rotational speed of the cutting elements is not required to enable a flow through the screen or to prevent the screen from clogging up. In particular, it is not necessary for the cutting elements of the comminution apparatus to rotate at all when the screen is not clogged up and a throughflow is ensured. Since, however, the comminution performance of the known comminution apparatus cannot be set, energy is unnecessarily consumed and wear of the cutting apparatus is accelerated.

To solve this problem, some users therefore make the transfer to using a respective dedicated comminution apparatus for each specific use case, the dedicated comminution apparatus being optimized for the respective use case in terms of the required comminution performance. This solution approach is clearly extremely expensive for the user, not just in terms of procuring it but also in terms of operation and maintenance. Furthermore, this solution approach leads to comparatively long stoppage times of the comminution apparatuses, during which they stand unused at the designated operating sites.

Users not wishing to operate multiple comminution apparatuses for the respective use cases must regularly disassemble the comminution apparatus insofar as they can adapt the comminution performance of the comminution apparatus to the respective use case, for example in order to minimize the contact pressure of the two cutting elements between one another to minimize the comminution performance by correspondingly interchanging a biasing spring with a lower spring stiffness.

However, in the prior art there is a disadvantage to the effect that it is not easily possible for a user of such a comminution apparatus to adapt the comminution performance, in particular to adapt it in such a way that it is optimal for use taking into consideration the wear on the cutting elements and thus in terms of the service life of the comminution apparatus.

### SUMMARY OF THE INVENTION

The invention is therefore based on the object of providing a solution which overcomes the disadvantages of the known comminution apparatuses. In particular, the invention is based on the object of providing a solution which enables user-friendly and at the same time optimal operation of a comminution apparatus irrespective of the use case of the user, together with a service life which is as long as possible.

This object is achieved according to a first aspect of the invention by providing a comminution apparatus described in the introduction which is designed with the possibility, during operation, of operation in a first operating mode and at least in a second operating mode different from the first operating mode to comminute the solids-containing medium, wherein the comminution apparatus can be set between the first operating mode and the at least second operating mode by means of a control apparatus to comminute a solids-containing medium. In particular, it is preferred for the comminution apparatus to be settable between the first operating mode and the at least second operating mode during operation of the comminution apparatus. Preferably, the comminution apparatus is designed to set the desired first or the at least second operating mode during operation in automated fashion.

According to this aspect of the invention, operation of the comminution apparatus in different operating modes by means of the control apparatus is enabled. This makes it possible for the user to comfortably operate the comminution apparatus with the optimum operating mode depending on the use case. In particular, the user can comfortably select the operating mode best suited to them from a list of operating modes depending on the desired comminution performance and the desired usage and wear of the comminution apparatus.

A first operating mode can, for example, be an operating mode in which the comminution apparatus is operated ecologically (eco operating mode). In this eco operating mode, the comminution apparatus is, for example, set such that the usage and also the wear for the comminution performance are, to be precise, relatively low—the first and the second cutting element operate, for example, with a relatively low contact pressure against one another. This minimizes the operating and wear costs and can, for example, also minimize the power consumption that depends on the rotational speed. The comminution apparatus according to the invention can be operated in the eco operating mode, for example, when the operation of the comminution apparatus is aimed at protecting machines, for example pumps, which are disposed downstream of the comminution apparatus in the flow direction. Although in the eco operating mode the comminution power is relatively low, the protection of downstream machines does not depend on it.

An at least second operating mode is for example an operating mode in which an excellent comminution result (maximum comminution power) can be achieved, for example cutting fibres in a solids-containing medium to fibre lengths of 2 mm. This is possible, for example, when the cutting apparatus of the comminution apparatus is operated at a high rotational speed, while the solids-containing medium is delivered only with a relatively low throughflow velocity. In particular, for a clean cut a high contact pressure between the cutting elements is preferred, in order that the solids in the solids-containing medium are cut and not squeezed or the like. This second operating mode, in which a maximum comminution performance is sought, is relevant, for example, when preparing flavourings or dyes. The maximum comminution performance should ensure that the solids in the solids-containing medium are cut up into parts which are as small as possible.

In a further operating mode of the comminution apparatus, it is possible, for example, to maximize the throughflow velocity of the solids-containing medium that is to be comminuted (maximum throughput). This can be achieved when the delivery performance of the pump delivering the solids-containing medium is high. The demand on the comminution performance may be rather low here, i.e., it hinges less on the contact pressure or the rotational speed of the cutting elements. The application is advantageous, for example, when the solids-containing medium is to be delivered from a first container to a second container within a limited time window, as is the case, for example, when filling a tanker. In this application, it only matters that delivery is performed with a high throughput and possible machines disposed downstream in the flow direction, such as a pump, are not damaged and there is no interruption. In this use case, the imperative resulting pressure loss at the cutting apparatus also does not matter.

It should be understood that the comminution apparatus can be operated according to the invention at least in two different operating modes. One operating mode is in particular a mode in which the comminution apparatus is operated for comminution of the solids-containing medium. If the comminution apparatus is in a state which is not suitable for comminuting the solids-containing medium, this state is not understood to be an operating mode within the meaning of the invention. In particular, for example an idle mode or standby mode of the comminution apparatus, in which although the comminution apparatus is switched on it is not operated to comminute the solids-containing medium, is not an operating mode within the meaning of the invention. Preferably, an operating mode is a mode in which the comminution apparatus is operated in such a way that the comminution apparatus is suitable for comminuting the solids-containing medium.

The comminution apparatus can in principle be set between the first operating mode and the at least second operating mode. In particular, the comminution apparatus can be switched back and forth between the first operating mode and the at least second operating mode. It may be preferable for the comminution apparatus to be automatically switchable back and forth between the first operating mode and the at least second operating mode. In particular, it may be preferable to automatically switch the comminution apparatus back and forth between the first operating mode and the at least second operating mode depending on measured variables, for example operating parameters, on vibrations of the comminution apparatus, on a hollow chamber pressure within the comminution apparatus, a fill level within the comminution hollow chamber and/or the like, and/or a use case. In the case of a comminution apparatus which can be set between the first operating mode and the at least second operating mode, preferably the first operating mode and the at least second operating mode are stored or storable in a program on the comminution apparatus itself or the control apparatus assigned to the comminution apparatus.

In particular, the comminution apparatus has a control apparatus, which is designed to control the comminution apparatus. In particular, a control apparatus designed to operate the comminution apparatus depending on the operating mode that is set is provided. The control apparatus may, for example, be incorporated in a computer unit. The computer unit may, for example, comprise a processor. In particular, the computer unit is, for example, a personal computer, a server, or the like. It should be understood that the comminution apparatus and the control apparatus can be or are coupled to one another in signalling terms. In particular, the control apparatus is designed in such a way that the comminution apparatus can be operated depending on the selected operating mode.

Preferably, the first operating mode and the at least second operating mode are stored on a memory unit. In particular, it may be provided that the memory unit is incorporated in a control apparatus, which is designed to control the comminution apparatus depending on the selected operating mode. It may also be provided that the first operating mode and the at least one second operating mode are stored on a control apparatus which is coupled in signalling terms to the comminution apparatus.

Preferably, the operating mode of the comminution apparatus can be set manually. For example, the comminution apparatus may have an input apparatus, for example a display, in particular a touch display, and/or a keyboard and/or a computer mouse and/or buttons and/or similar input elements, with which the different operating modes of the comminution apparatus can be selected. It may likewise be preferable for the operating mode of the comminution apparatus to be settable or set in automated fashion, for example depending on properties of the solids-containing medium that is to be comminuted and/or on properties of the comminuted solids-containing medium and/or on a distance between the first and the second cutting element. This presupposes that corresponding sensors are disposed upstream and/or downstream of the cutting apparatus in the solids-containing medium to measure the properties of the solids-containing medium that is to be comminuted or is comminuted and/or are disposed on the cutting apparatus. Properties of the solids-containing medium are, for example, fibre length or degree of homogeneity of the solids-containing medium.

For the operation of the comminution apparatus, the drive shaft is coupled to the drive apparatus. The drive apparatus is preferably an electric motor. It is also conceivable for the drive apparatus to be a hydraulic motor. The drive apparatus is preferably designed in such a way that its rotational speed can be regulated or controlled. In particular, the drive apparatus can be controlled or regulated depending on the operating mode. Therefore, it is provided in particular that the drive apparatus is coupled in signalling terms to the control apparatus. To regulate the rotational speed, it is preferably provided that the drive apparatus comprises a frequency converter. The frequency converter makes it possible to set the rotational speed of the drive apparatus depending on the use case in uncomplicated fashion. For example, the drive apparatus can be operated with a low rotational speed in the eco operating mode, in which a high comminution performance is not necessary, and with a high rotational speed in an operating mode providing maximum comminution performance.

For the operation of the comminution apparatus, the drive shaft is in turn coupled to the first cutting element of the cutting apparatus. It is provided that the first cutting element rotates with the drive shaft. It is also preferred for the second cutting element to be non-rotatable, by contrast to the first cutting element. In particular, it is provided that the second cutting element is stationary. It may also be preferred for the first and/or the second cutting element to be mounted so as to be movable in translation. It is preferably provided that the first cutting element is movable in translation relative to the second cutting element. In particular, it is provided that the first cutting element is mounted and/or disposed so as to be movable in rotation and translation and the second cutting element is stationary.

It is preferably provided that the drive shaft is in the form of a hollow shaft.

It should be understood that the cutting apparatus may have one or more first cutting elements. In particular, it is preferred for the cutting apparatus to have two, three, four, or more first cutting elements. In the case of a cutting apparatus comprising multiple first cutting elements, the first cutting elements are preferably disposed equidistantly with respect to the first movement path. The first movement path is in particular a circular movement path. For example, in the case of the arrangement of two first cutting elements the two cutting elements are offset by 180° with respect to the first movement path, in the case of the arrangement of three first cutting elements the first cutting elements are offset by 120° with respect to the first movement path, or in the case of the arrangement of four first cutting elements the first cutting elements are offset by 90° with respect to the first movement path, etc.

The statements made relating to the first cutting element preferably apply to the second cutting element. It may be preferable for the first cutting element and second cutting element to have the same structure. However, it is particularly preferable for the first cutting element to have a different design to the second cutting element.

The solution according to the invention provides a comminution apparatus which enables operation which can be set in user-friendly fashion and at the same time is optimal of a comminution apparatus for various use cases. In particular, by virtue of the comminution apparatus according to the invention it is not necessary to provide separate comminution apparatuses for every use case with the optimum operating mode for the respective use case. This leads not only to considerable cost savings in the purchase, but also reduces the costs for operation and maintenance considerably.

For the advantages, embodiment variants, and embodiment details of the first aspect and the possible developments, reference is additionally made to the description relating to the corresponding features, advantages, embodiment variants, and embodiment details of the further aspects.

The object is also achieved according to a second aspect of the invention by providing a comminution apparatus described in the introduction, such that the first cutting element and the second cutting element are movable in translation relative to one another on a second movement path, wherein a detection apparatus is provided and designed to measure a contact pressure of the first cutting element against the second cutting element and/or to detect an arrangement of the first cutting element and the second cutting element relative to one another, wherein an adjusting apparatus is provided and designed to displace the first cutting element and the second cutting element relative to one another on a second movement path to set the distance between cutting edges, until a desired contact pressure and/or distance between the first cutting element and the second cutting element is set. In particular, the adjusting apparatus is designed to set the first cutting element and the second cutting element depending on the contact pressure and/or distance between cutting edges measured by the detection apparatus.

Preferably, the desired distance between the first cutting element and the second cutting element is 0 mm. In particular, the desired contact pressure is a preset contact pressure. The desired contact pressure is in particular a contact pressure at which the desired comminution performance is ensured and/or the desired wear behaviour occurs. Preferably, the distance between the first cutting element and the second cutting element is 0 mm and the contact pressure between the first cutting element and the second cutting element is minimal. In this preferred arrangement of the first and the second cutting element, lifting-off of the first cutting element from the second cutting element is prevented and at the same time operation with minimum wear is enabled. If there is a minimum contact pressure, the first cutting element still does not lift off from the second cutting element. It may also be preferable for the distance between the first cutting element and the second cutting element to be 0 mm and the contact pressure to be greater than the minimum contact pressure.

The second movement path preferably runs substantially orthogonally in relation to the first movement path. The adjusting apparatus can be designed to adjust the first cutting element relative to the second cutting element, for example in the form of a hydraulic and/or electric and/or pneumatic adjusting apparatus. In particular, the adjusting apparatus is a linear drive, preferably an electric linear drive, for example an electric cylinder. In particular, the adjusting device makes it possible not just to set the position of the first cutting element relative to the second cutting element. An electric linear drive has the advantage of omitting a separate hydraulic system or a pneumatic system for controlling/regulating the contact pressure. In particular, as a result the requirement for the user to have to set the contact pressure themselves by setting a corresponding pneumatic or hydraulic pressure does not apply.

Preferably, the adjusting apparatus is designed to set and/or control and/or regulate a contact pressure between the first and the second cutting element. In particular, the adjusting apparatus is designed to actuate or regulate the comminution apparatus depending on a desired contact pressure. If, for example, the measured contact pressure is below the desired contact pressure, the adjusting apparatus acts on the first and the second cutting element in such a way that the contact pressure increases until the measured contact pressure corresponds to the desired contact pressure. If the measured contact pressure is higher than the desired contact pressure, the arrangement of the first and the second cutting element relative to one another is modified by means of the adjusting apparatus in such a way that the measured contact pressure falls until the desired contact pressure is reached. Preferably, to that end the detection apparatus has individual ones or all of the features and advantages as described below later on in detail with respect to the detection apparatus.

Preferably, the adjusting apparatus is coupled in signalling terms to a control apparatus described in this document. It may be preferable to provide a corresponding data transmission unit to that end, in order to actuate the adjusting apparatus by means of the control apparatus to set a desired contact pressure and/or distance between the first and the second cutting element. This makes it possible to quickly and easily set the comminution performance of the comminution apparatus in a particularly preferred way. An electrically actuated adjusting apparatus makes it possible to automatically adapt the contact pressure particularly easily, so that the contact pressure measured by a detection apparatus corresponds to a desired contact pressure.

For the advantages, embodiment variants, and embodiment details of the second aspect and the possible developments, reference is additionally made to the description relating to the corresponding features, advantages, embodiment variants, and embodiment details of the further aspects.

The object is also achieved according to a third aspect of the invention by providing a comminution apparatus described in the introduction, such that the cutting apparatus is disposed within a comminution hollow chamber between an opening outlet, through which the comminuted solids-containing medium can flow out of the comminution hollow chamber, and an opening inlet, through which the solids-containing medium that is to be comminuted can flow into the comminution hollow chamber, wherein the comminution apparatus has a sealing arrangement comprising a sealing fluid pump apparatus, which has a pump inlet and a pump outlet, and a sealing chamber which is connected to the pump outlet, is adjacent to the comminution hollow chamber, has a fluid pressure applied to it via the pump outlet, which fluid pressure results from the fluid pressure difference generated by the sealing fluid pump apparatus, and by means of this fluid pressure seals off the comminution hollow chamber against the egress of solids-containing medium from the comminution hollow chamber along the drive shaft.

In particular, the sealing arrangement is designed in such a way that the fluid pressure can be set or varied within the sealing chamber. Preferably, the sealing arrangement is designed in such a way that the fluid pressure within the sealing chamber can be set to a desired fluid pressure. It is also preferred for the sealing arrangement to be designed in such a way that the fluid pressure within the sealing chamber can be set or varied depending on a pressure within the comminution hollow chamber. In particular, the sealing arrangement may be designed such that a fluid pressure is automatically set in the sealing chamber depending on the pressure within the comminution hollow chamber. In particular, the sealing arrangement makes it possible to set a sealing chamber pressure within the sealing chamber which is above the hollow chamber pressure in the comminution hollow chamber and is preferably at least 0.5 bar above the hollow chamber pressure.

This has the advantage that the bearing of the drive shaft and the drive unit of the comminution apparatus are not contaminated by the solids-containing medium. In particular, this has the advantage of enabling a long service life of the comminution apparatus and thus easy and cost-effective operation of the comminution apparatus.

In relation to the further advantages, embodiment variants, and embodiment details of the third aspect and the possible developments, reference is additionally made to the description relating to the corresponding features, advantages, embodiment variants, and embodiment details of the further aspects.

According to a preferred embodiment of the third aspect, it is provided that a sealing chamber pressure within the sealing chamber is greater than the hollow chamber pressure within the comminution hollow chamber, wherein preferably the sealing chamber pressure is at least 0.5 bar greater than the hollow chamber pressure.

The comminution apparatus is thus configured such that the sealing chamber pressure prevails in the sealing chamber and the hollow chamber pressure prevails in the comminution hollow chamber. According to this preferred embodiment, the sealing chamber pressure is set such that the sealing chamber pressure is greater than the hollow chamber pressure. In particular, the sealing chamber pressure is at least 0.5 bar more than the hollow chamber pressure. The sealing chamber pressure is preferably set automatically depending on the hollow chamber pressure.

The hollow chamber pressure is preferably measured within the comminution hollow chamber. In particular, one or more pressure sensors, also referred to as hollow chamber pressure sensor, are provided within and/or on the comminution hollow chamber to measure the hollow chamber pressure. Preferably, a pressure sensor is disposed in the region of the opening outlet. In addition or as an alternative, a pressure sensor may be disposed in the region of the opening inlet. The hollow chamber pressure can correspond to the value from one pressure sensor or, in the event of multiple pressure sensors, to a mean value of the measurement values that were measured. In particular, it may also be preferred for the hollow chamber pressure, in the event of multiple pressure sensors, to correspond to the respective maximum measured pressure at the point in time at which the measurement of the hollow chamber pressure was taken by the pressure sensors.

According to a preferred embodiment of the second and/or third aspect, it is provided that the comminution apparatus is designed for the possibility, during operation, of operating in a first operating mode and at least in a second operating mode different from the first operating mode.

According to this embodiment, what is provided is a comminution apparatus which enables operation which can be set in user-friendly fashion and at the same time is optimal of a comminution apparatus for various use cases. In particular, by virtue of the comminution apparatus according to the invention it is not necessary to provide separate comminution apparatuses for every use case with the optimum operating mode for the respective use case. This leads not only to considerable cost savings in the purchase, but also reduces the costs for operation and maintenance considerably.

For this preferred embodiment, reference is made in particular to the corresponding features, advantages, embodiment variants, and embodiment details of the first aspect. Particularly preferred possible embodiments of the comminution apparatus of the first, second, and third aspects of the invention and their advantages are described below.

According to a preferred development, it is provided that the comminution of the solids-containing medium during operation of the comminution apparatus in the first operating mode and at least in the second operating mode different from the first operating mode depends on one or more of the following operating parameters:
a rotational speed of the first cutting element, and/or
a contact pressure between the first cutting element and the second cutting element, and/or
a cutting edge distance between the at least one first cutting edge and the at least one second cutting edge, and/or
a volumetric flow rate of the solids-containing medium through the cutting apparatus, and/or
a hollow chamber inlet pressure upstream of the cutting apparatus, in particular in the region of an opening inlet, and/or
a hollow chamber outlet pressure downstream of the cutting apparatus, in particular in the region of an opening outlet, and/or
a hollow chamber differential pressure, which corresponds to the difference between the hollow chamber inlet pressure and the hollow chamber outlet pressure,
   wherein the first operating mode and the at least second operating mode differ in terms of a target characteristic of at least one operating parameter of the at least one operating parameter.

The rotational speed of the first cutting element preferably corresponds to the rotational speed of the drive shaft or is proportional to the rotational speed of the drive shaft. In particular, it is provided that the rotational speed of the first cutting element preferably corresponds to the rotational speed of the drive apparatus or is proportional to the rotational speed of the drive apparatus. It may be preferable for a transmission to be disposed between the drive apparatus and the drive shaft and/or between the drive shaft and the first cutting element. The transmission is designed to mechanically couple the drive apparatus to the drive shaft and/or the drive shaft to the first cutting element fixedly in terms of torque. The transmission can be designed to increase and/or decrease the rotational speed of the drive apparatus to the rotational speed of the first cutting element. The rotational speed is set by means of the control apparatus depending on the operating mode that is set. If, for example, a high comminution performance is desired, a relatively high rotational speed of the first cutting element is set. If, rather, the comminution performance has little relevance to a specific application, the corresponding operating mode can provide operation of the comminution apparatus at a rather lower rotational speed, with the result that the wear of the cutting elements is minimized and thus the service life of the comminution apparatus is maximized.

The contact pressure is in particular to be understood as meaning that pressure which prevails between the first and the second cutting element, in particular between the cutting edges of the first and the second cutting element. Generally, the contact pressure between the first and the second cutting element is zero if the first and the second cutting element do not lie directly on one another. If, however, during operation of the comminution apparatus a solid material that is to be comminuted, for example a branch or the like, passes between the first and the second cutting element, in spite of the spaced-apart arrangement of the two cutting elements in relation to one another there can be a contact pressure between the first and the second cutting element. The greater the extent to which the cutting elements lie on one another, the higher the contact pressure is. However, the contact pressure should not be so high that a relative movement between the first cutting element and the second cutting element is prevented. This is the case when the frictional moment resulting from the contact pressure is greater than the drive moment of the drive apparatus.

The distance between cutting edges preferably corresponds to the distance between the cutting edges of the first and the second cutting element. In particular, the distance between cutting edges corresponds to the distance between the first and the second cutting element orthogonally in relation to the first movement path and/or parallel to the second movement path.

The volumetric flow rate of the solids-containing medium through the cutting apparatus is in particular the volumetric flow rate at which the solids-containing medium flows into the comminution apparatus through an inlet opening and out of the comminution apparatus through an outlet opening. It should be understood in particular that the density of the solids-containing medium can be considered to be substantially constant, and therefore the volumetric flow rate is substantially proportional to the mass flow rate.

The hollow chamber inlet pressure is preferably measured upstream of the cutting apparatus. In particular, the hollow chamber inlet pressure is measured in the region of an opening inlet. It is also preferable to measure the hollow chamber inlet pressure in the region between the opening inlet and the cutting apparatus, in particular the first and/or the second cutting element.

The hollow chamber outlet pressure is preferably measured downstream of the cutting apparatus. In particular, the hollow chamber outlet pressure is measured in the region of an opening outlet. It is also preferable to measure the hollow chamber outlet pressure in the region between the opening outlet and the cutting apparatus, in particular the first and/or the second cutting element.

The hollow chamber differential pressure is the differential pressure resulting from the difference between the hollow chamber inlet pressure and the hollow chamber outlet pressure. The hollow chamber differential pressure is in particular an indication of the degree of loading on the comminution apparatus.

A target characteristic is, in particular, a target value for an operating parameter. In particular, a target characteristic is a desired value for an operating parameter.

According to a preferred embodiment, it is also provided that a first selection of the operating parameters from the at least one operating parameter in the first operating mode comprises or can comprise target characteristics which are smaller than the target characteristics of the corresponding operating parameters in the at least second operating mode, and/or a selection of the operating parameters from the at least one operating parameter in the first operating mode comprises or can comprise target characteristics which are larger than the target characteristics of the corresponding operating parameters in the at least second operating mode, and/or a third selection of the operating parameters from the at least one operating parameter in the first operating mode comprises or can comprise target characteristics which correspond to the target characteristics of the corresponding operating parameters in the at least second operating mode.

This preferred embodiment has the advantage that the comminution apparatus can be operated so as to be individually matched to the respective use case.

In another preferred embodiment, what is provided is a comminution apparatus which has an adjusting apparatus, which is designed to displace the at least first cutting element and the at least second cutting element relative to one another on a second movement path to set the distance between cutting edges, and/or is designed to transfer a force along the second movement path to set the contact pressure.

Preferably, the second movement path extends orthogonally in relation to the first movement path. In particular, the second movement path is a linear path. Preferably, the second movement path extends parallel to and/or coaxially with the axis of rotation of the first movement path.

It is preferably provided that the adjusting apparatus generates an adjusting force, in particular an axial force, which acts on the cutting elements. In particular, what is provided is an adjusting element, for example a tie rod, to which the at least first cutting element is connected. The adjusting element and the first cutting element are preferably connected to one another in a form fit and/or force fit and/or integral bond. An adapter, by way of which the first cutting element and the adjusting element are connected to one another, may be provided.

It may be provided that the adjusting element is disposed within the drive shaft. Preferably, the adjusting element is disposed within the drive shaft so as to be relatively displaceable, in particular along the axis of rotation of the drive shaft, wherein the drive shaft is in the form of a hollow shaft. In particular, the drive shaft may have a bearing unit, which is designed to mount the adjusting element within the drive shaft for translational displacement. In particular, the adjusting element is mounted axially within the drive shaft. This has the advantage that the comminution performance of the comminution apparatus can be set selectively, depending on the use case. In particular, this makes it possible to also reduce the contact pressure, this leading to lower wear and thus to a longer service life of the comminution apparatus.

Furthermore, according to a preferred development, it is provided that the adjusting apparatus is or comprises an electrically actuable adjusting apparatus and/or a hydraulically actuable adjusting apparatus and/or a mechanically actuable adjusting apparatus. Preferably, the adjusting apparatus has an adjusting apparatus drive unit, which is designed to displace the first cutting element with respect to the second cutting element. It is preferred for the adjusting apparatus to have an adjusting element which is coupled to the first cutting element. Preferably, the adjusting element is coupled to the adjusting apparatus drive unit. In particular, it is provided that the first cutting element is adjusted with respect to the second cutting element by the adjusting apparatus drive unit via the adjusting element. In particular, the adjusting apparatus drive unit is designed to displace the adjusting element axially within the drive shaft. Preferably, for this the adjusting apparatus drive unit is supported with respect to the drive shaft.

In particular, according to a preferred development of the comminution apparatus, it is provided that the electrically actuated adjusting apparatus is an electric linear drive, in particular an electric cylinder, or comprises it in the form of an adjusting apparatus drive unit. In particular, this makes it possible to set the contact pressure particularly easily and individually. In particular, an adjusting device of this type can be actuated or regulated particularly easily. In particular, such an electrically actuated adjusting apparatus has the advantage that it can react particularly quickly.

The electric cylinder is preferably coupled to the adjusting element. In particular, it may be preferable that a hydraulic adjusting unit, for example a hydraulic ram, couples the electric cylinder to the adjusting element. For example, the electric cylinder presses on the hydraulic adjusting unit with a desired, in particular established, adjusting force. This causes the buildup of a defined pressure, which acts on the adjusting element and thus brings about a defined adjustment of the first cutting element with respect to the second cutting element, or a defined contact pressure between the corresponding cutting elements.

It is also provided according to a preferred development that the second cutting element is a perforated disc and a plurality of second cutting edges are formed by openings in walls delimiting the perforated disc. Preferably, the second cutting element is in the form of a type of screen, in order to retain solids of a certain size to protect machines, for example pumps, which are downstream in the flow direction.

According to another preferred embodiment, it is provided that the first cutting element comprises a blade which is disposed rotatably along the first movement path, wherein the blade is preferably disposed rotatably on a surface of the perforated disc.

According to another preferred development, the comminution apparatus has an opening inlet, through which the solids-containing medium that is to be comminuted can enter the comminution apparatus during operation, and an opening outlet, through which the comminuted solids-containing medium can leave the comminution apparatus during operation, wherein a comminution hollow chamber fluidically connects the opening outlet, which is downstream in the conveying direction of the solids-containing medium, to the opening inlet.

According to another preferred embodiment of the comminution apparatus, it is provided that the cutting apparatus is disposed within the comminution hollow chamber between the opening outlet and the opening inlet.

It is also provided according to a preferred development that the comminution apparatus has a pumping apparatus for delivering the solids-containing medium through the cutting apparatus at the volumetric flow rate. Preferably, the pumping apparatus is coupled in signalling terms to the control apparatus. In particular, the pumping apparatus is designed to generate a volumetric flow rate depending on the operating mode. In particular, the pumping apparatus is designed to vary the volumetric flow rate depending on the operating mode.

It is furthermore provided according to a preferred development that the pumping apparatus is or comprises an adjustable pump for setting the volumetric flow rate of the solids-containing medium. In particular, the pumping apparatus is downstream of the cutting apparatus and/or of the opening outlet in the conveying direction of the solids-containing medium.

According to another preferred development, the comminution apparatus has a detection apparatus, which is designed to measure actual characteristics of the operating parameters, in particular a lifting off of the first cutting element and the second cutting element from one another and/or to measure the distance between cutting edges. An actual characteristic is in particular an actual value of an operating parameter. An actual characteristic corresponds to the value of an operating parameter with which the comminution apparatus is operated at the point in time the actual characteristic is measured.

To measure the actual characteristic, the detection apparatus in particular comprises a rotational speed sensor for measuring an actual rotational speed of the drive shaft and/or of the first cutting element. In addition or as an alternative, it is provided that the detection apparatus comprises a pressure loss sensor for measuring an actual pressure loss. Furthermore, it may additionally or alternatively be provided that the detection apparatus comprises a fill level monitoring sensor for measuring an actual fill level of the solids-containing medium in the comminution apparatus. It is also possible, in addition or as an alternative, for the detection apparatus to have a vibration sensor for detecting vibration of the comminution apparatus. It is also conceivable for the detection apparatus to additionally or alternatively have a volumetric flow rate sensor for detecting an actual volumetric flow rate of the solids-containing medium. Furthermore, the detection apparatus may additionally or alternatively comprise a pressure sensor for measuring an actual contact pressure. In addition or as an alternative, the comminution apparatus may also have one or more hollow chamber pressure sensors for measuring a hollow chamber pressure in the comminution hollow chamber. In addition or as an alternative, it may lastly be provided that the detection apparatus comprises a distance sensor for measuring an actual distance between cutting edges.

Preferably, the detection apparatus is coupled in signalling terms to the control apparatus. In particular, it is provided that the detection apparatus provides at least one actual characteristic of an operating parameter to the control apparatus to control the comminution apparatus. It is preferably provided that the detection apparatus provides actual characteristics of multiple operating parameters to the control apparatus to control the comminution apparatus.

According to a preferred embodiment, it is also provided that the comminution apparatus has an input apparatus, which is designed for selection and/or input of the operating mode and/or the target characteristics of the operating parameters for the respective operating mode. The input apparatus comprises, for example, a display, in particular a touch display and/or a keyboard and/or a computer mouse and/or buttons and/or control units and/or the like for selecting and/or inputting an operating mode. In particular, the input apparatus may be designed to set and/or establish a target characteristic of an operating parameter.

In addition or as an alternative, it may be preferable for the comminution apparatus to comprise a drive apparatus, which is coupled fixedly in terms of torque to the drive shaft and/or the cutting apparatus to drive the cutting apparatus.

Furthermore, it may additionally or alternatively be preferred for the comminution apparatus to comprise a control apparatus, which can be or is coupled in signalling terms to the adjusting apparatus and/or the drive apparatus and/or the pumping apparatus and/or the detection apparatus and/or the input apparatus. The control apparatus may be designed to measure and/or store the actual characteristics of the operating parameters, and/or to compare the actual characteristics of the operating parameters with the target characteristics of the operating parameters, and/or to set the target characteristic of the operating parameters depending on the operating mode, and/or to set and/or control and/or regulate the characteristics of the operating parameters depending on the comparison of the actual characteristics of the operating parameters with the target characteristics of the operating parameters.

The object stated in the introduction is achieved according to a fourth aspect of the invention by a method for controlling a comminution apparatus, in particular a comminution apparatus described above, to comminute a solids-containing medium, wherein the method comprises the steps of starting the comminution apparatus, selecting an operating mode from a list of operating modes, wherein the list of operating modes comprises a first operating mode and at least a second operating mode different from the first operating mode, and comminuting the solids-containing medium by means of the comminution apparatus depending on the selected operating mode.

For the advantages, embodiment variants, and embodiment details of the fourth aspect and the possible developments, reference is additionally made to the description relating to the corresponding features, advantages, embodiment variants, and embodiment details of the further aspects.

In a preferred development, the method comprises a step of determining a target characteristic of at least one operating parameter for the first operating mode and/or for the at least one second operating mode, wherein the first operating mode and the at least one second operating mode differ in terms of a target characteristic of at least one operating parameter.

According to another preferred development, the method comprises a step of setting a target characteristic of at least one operating parameter of the at least one operating parameter depending on the selected operating mode, and a step of operating the comminution apparatus depending on the target characteristic of the at least one operating parameter.

According to a preferred embodiment, the method also comprises a step of measuring an actual characteristic of the at least one operating parameter, and/or a step of comparing the measured actual characteristic with a target characteristic of the at least one operating parameter, and/or a step of adapting the characteristic of the at least one operating parameter until the target characteristic of the at least one operating parameter is reached.

The object stated in the introduction is achieved according to a fifth aspect of the invention by a method for controlling a comminution apparatus, in particular a comminution apparatus described above, to comminute a solids-containing medium, wherein the method comprises the following steps: minimizing a contact pressure by means of an adjusting apparatus until the lifting-off of an at least one first cutting edge and an at least one second cutting edge from one another is detected, and holding the at least one first cutting edge and the at least one second cutting edge in a position from one another in which the contact pressure is minimal.

For the advantages, embodiment variants, and embodiment details of the fifth aspect and the possible developments, reference is additionally made to the description relating to the corresponding features, advantages, embodiment variants, and embodiment details of the further aspects.

The object stated in the introduction is achieved according to a sixth aspect of the invention by a method for controlling a comminution apparatus, in particular a comminution apparatus described above, to seal off the comminution apparatus during the comminution of a solids-containing medium, wherein the method comprises the following steps: determining a hollow chamber pressure within the comminution hollow chamber by means of a pressure sensor, and setting a sealing chamber pressure within the sealing chamber above the hollow chamber pressure, in particular at least 0.5 bar above the hollow chamber pressure, by means of a sealing fluid pump apparatus.

For the advantages, embodiment variants, and embodiment details of the sixth aspect and the possible developments, reference is additionally made to the description relating to the corresponding features, advantages, embodiment variants, and embodiment details of the further aspects.

The object stated in the introduction is achieved according to a seventh aspect of the invention by a control apparatus for controlling a comminution apparatus, in particular a comminution apparatus described above, to comminute a solids-containing medium with a variable comminution performance, wherein the control apparatus is designed to carry out the steps of a method described above.

For the advantages, embodiment variants, and embodiment details of the seventh aspect and the possible developments, reference is additionally made to the description relating to the corresponding features, advantages, embodiment variants, and embodiment details of the further aspects.

### BRIEF DESCRIPTION OF THE DRAWINGS

Preferred embodiments of the invention are described by way of example with reference to the appended Figures, in which:

FIG. 1 shows an isometric sectional view of a comminution apparatus in a preferred embodiment;

FIG. 2 shows a side view of the comminution apparatus illustrated in FIG. 1;

FIG. 2a shows an illustration of a detail of the sealing arrangement illustrated in FIG. 2;

FIG. 3 shows an isometric view of the comminution apparatus illustrated in FIGS. 1 and 2;

FIG. 4 shows a schematic view of the elements coupled in signalling terms of the comminution apparatus illustrated in FIGS. 1 to 3;

FIG. 5 shows a schematic block diagram of a method for controlling a comminution apparatus in a preferred embodiment;

FIG. 6 shows a schematic block diagram of a method for controlling a comminution apparatus in another preferred embodiment; and

FIG. 7 shows a schematic block diagram of a method for sealing off the comminution apparatus during the comminution of a solids-containing medium.

### DETAILED DESCRIPTION OF THE EMBODIMENTS

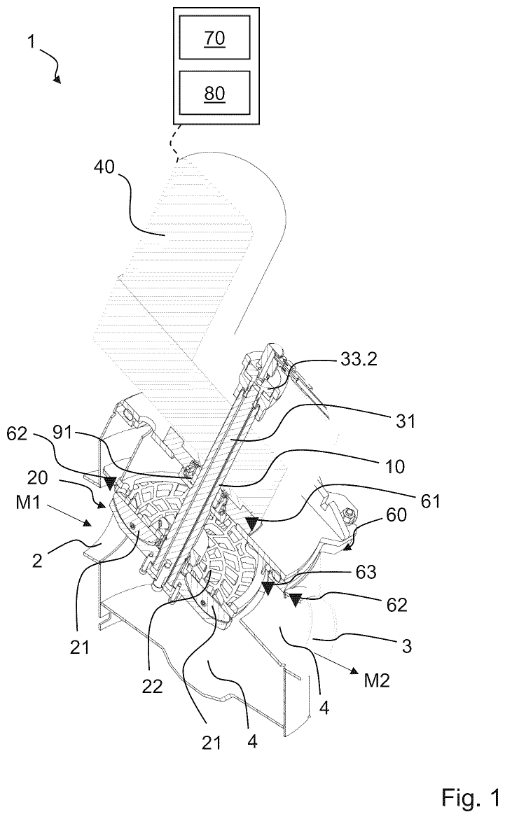

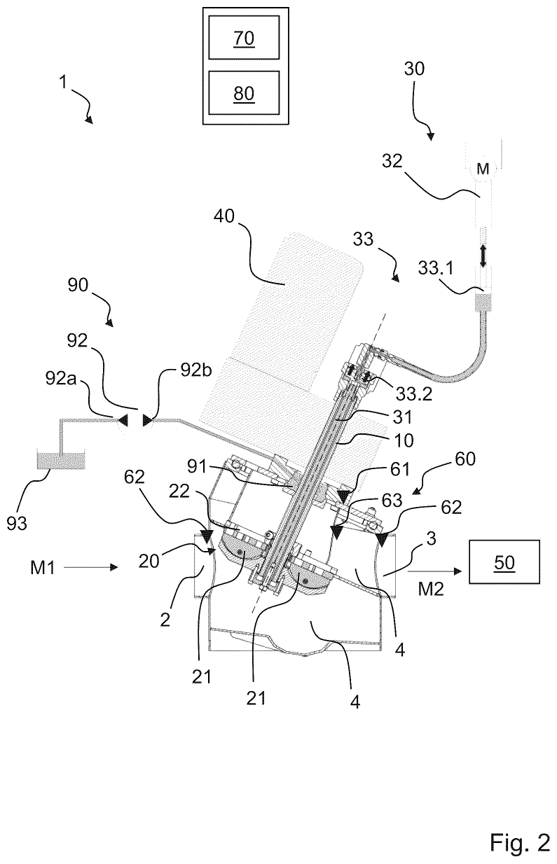

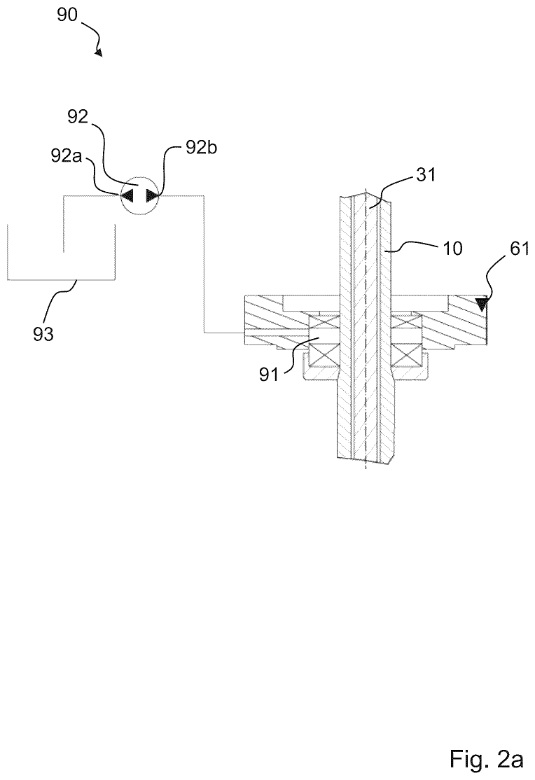

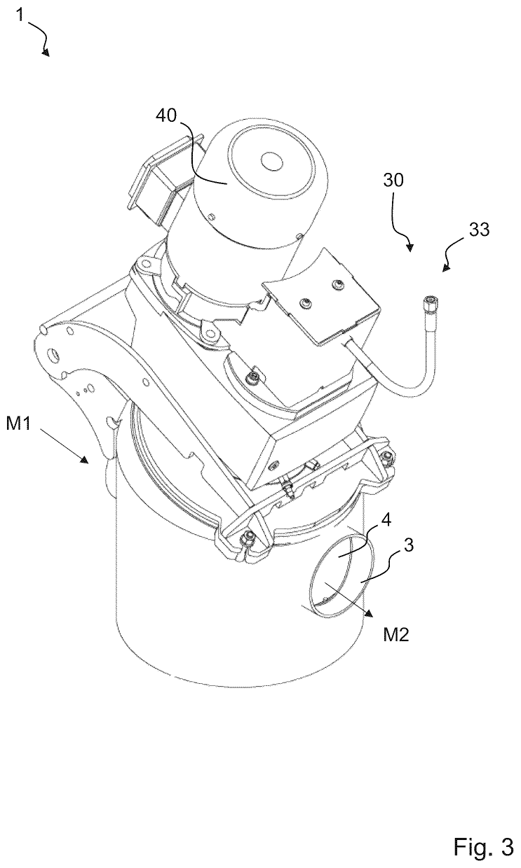

FIG. 1 shows an isometric sectional view of a comminution apparatus 1 in a preferred embodiment. FIG. 2 shows a side view and FIG. 3 shows an isometric view of the comminution apparatus 1 illustrated in FIG. 1.

The comminution apparatus 1 illustrated schematically in FIGS. 1, 2, and 3 is designed for comminuting a solids-containing medium. Depending on the use case, the comminution performance of the comminution apparatus 1 can be varied. To this end, a user can set a preferred operating mode on the comminution apparatus 1 by means of a control apparatus 80, with the result that the desired comminution performance is set and at the same time the wear is minimized, or the service life of the comminution apparatus 1 is maximized. In a first operating mode, for example, the comminution performance, but also the wear of the comminution apparatus 1, can be relatively low. In a second operating mode, for example and by contrast, a maximum comminution performance may be sought which is associated with comparatively higher wear of the comminution apparatus 1.

The comminution performance and similarly also the wear of the comminution apparatus 1 depend on operating parameters, or target characteristics of the operating parameters, with which the comminution apparatus 1 is operated. It should be understood that the various operating modes, or the first and the at least one second operating mode, differ at least in terms of a target characteristic of an operating parameter. The operation of the comminution apparatus, or comminution performance of the comminution apparatus 1, can depend on multiple operating parameters. Essential operating parameters, a change in the characteristic of which leads to a modified comminution performance of the comminution apparatus 1, are a rotational speed of a first cutting element 21, and/or a contact pressure between a first and a second cutting element 21, 22, and/or a distance between the cutting edges of the first and the second cutting element 21, 22, and/or a volumetric flow rate of the solids-containing medium M1, M2.

It is preferably provided that a first selection of the operating parameters from the at least one operating parameter in the first operating mode comprises target characteristics which are smaller than the target characteristics of the corresponding operating parameters in the at least one second operating mode. It is also possible for a second selection of the operating parameters from the at least one operating parameter in the first operating mode to comprise target characteristics which are larger than the target characteristics of the corresponding operating parameters in the at least one second operating mode. Furthermore, it is preferably possible for a third selection of the operating parameters from the at least one operating parameter in the first operating mode to comprise target characteristics which correspond to the target characteristics of the corresponding operating parameters in the at least second operating mode.

To comminute the solids-containing medium, the comminution apparatus 1 has a drive shaft 10, which is coupled fixedly in terms of torque to a drive apparatus 40 comprising an electric motor. In this respect, the drive shaft 10 is mounted rotatably and is mechanically coupled to a cutting apparatus 20 to comminute the solids-containing medium. In this preferred embodiment, the drive apparatus 40 has a frequency converter, so that the rotational speed of the drive apparatus 40 and thus of the drive shaft 10 or of the cutting apparatus 20 can be set depending on a set or selected operating mode.

The cutting apparatus 20 is disposed in a comminution hollow chamber 4 of the comminution apparatus 1 between an opening inlet 2 and an opening outlet 3. During operation of the comminution apparatus 1, the solids-containing medium M1 that is to be comminuted is fed to the comminution hollow chamber 4 through the opening inlet 2. The cutting apparatus 20 comminutes the solids-containing medium M1 fed to the comminution hollow chamber 4, the medium then being discharged from the comminution hollow chamber 4 through the downstream outlet opening 3 in the form of comminuted solids-containing medium M2. To deliver the solids-containing medium M1, M2 at a volumetric flow rate, it is preferably provided to dispose a pumping apparatus 50 downstream of the opening outlet. It should be understood that the pumping apparatus 50 has an adjustable design, with the result that the volumetric flow rate at which the solids-containing medium M1, M2 is delivered through the comminution apparatus 1 can be set, in order to also enable a settable comminution performance in this respect.

To comminute the solids-containing medium M1, the cutting apparatus 20 has multiple first cutting elements 21 and a second cutting element 22. The first cutting elements 21 are in the form of blades and preferably have two cutting edges. The second cutting element 22 is in the form of a perforated disc and comprises more than two cutting edges, which are formed by the openings in walls delimiting the perforated disc. As a result of a relative movement of the first and second cutting edges relative to one another, solids in the solids-containing medium M1 are comminuted by a shearing movement of the cutting elements 21, 22 relative to one another. The shearing movement between the first cutting elements 21 and the second cutting element 22 is achieved in that the first cutting elements 21 are movable relative to the second cutting element 22. Specifically, the first cutting elements 21 and the second cutting element 22 are movable relative to one another during operation of the comminution apparatus 1 in such a way that the first cutting elements 21 are guided on a circular first movement path on a surface of the perforated disc with respect to the second cutting element 22. In this preferred embodiment of the comminution apparatus 1, it is provided that the second cutting element 22 is stationary within the comminution hollow chamber 4, while the first cutting elements 21 are mechanically coupled fixedly in terms of torque to the drive shaft 10 and can be rotated in the comminution hollow chamber 4.

In this preferred embodiment of the comminution apparatus 1, the first cutting elements 21 are mounted so as to be displaceable not only in rotation but also in translation with respect to the second cutting element 22. To this end, the comminution apparatus 1 has an adjusting apparatus 30, by means of which the first cutting elements 21 can be displaced in translation with respect to the second cutting element 22. The adjusting apparatus 30 makes it possible to set a distance between cutting edges of, and/or a contact pressure between, the first cutting elements 21 and the second cutting element 22. In the preferred embodiment of the comminution apparatus 1, the adjusting apparatus 30 has an electric cylinder as electric linear drive. The electric cylinder in particular means it is not necessary for a compressed-air connection. Furthermore, the user themselves no longer has to perform the setting operation. The adjusting apparatus 30 makes it possible for the first cutting elements 21 to be displaced with respect to the second cutting element 22 on a second movement path during operation depending on the selected operating mode, with the result that a desired distance between cutting edges and/or a desired contact pressure can be set. It should be understood that the second movement path extends orthogonally in relation to the first movement path, wherein the second movement path corresponds to a path for a linear movement which runs substantially parallel to, in particular coaxially with, an axis of rotation of the drive shaft 10.

The electric cylinder 32 is preferably coupled to the adjusting element 31. In particular, it may be preferable to provide a hydraulic adjusting unit 33, for example a hydraulic ram, which couples the electric cylinder 32 to the adjusting element 31. For example, the electric cylinder 32 presses on the hydraulic adjusting unit 33 with a desired, in particular established, adjusting force. To this end, it is provided, for example, that the hydraulic adjusting unit 33 has a master cylinder 33.1 in the form of a hydraulic cylinder and a slave cylinder 33.2 in the form of a hydraulic cylinder which are fluidically coupled to one another, for example by a hydraulics hose. In the present preferred embodiment, the electric cylinder 32 is mechanically coupled to the master cylinder 33.1, with the result that a displacement of the electric cylinder brings about a displacement of the master cylinder 33.1. The displacement of the master cylinder 33.1 in turn brings about a displacement of the slave cylinder 33.2 owing to the hydraulic coupling. The slave cylinder 33.2 is in turn mechanically coupled to the adjusting element 31, with the result that a displacement of the slave cylinder 33.2 brings about a displacement of the adjusting element. The adjusting apparatus 30 thus causes the buildup of a defined pressure, which acts on the adjusting element 31 and thus brings about a defined adjustment of the first cutting element 21 with respect to the second cutting element 22, or a defined contact pressure between the corresponding cutting elements. To this end, the adjusting element 31 is mounted so as to be axially displaceable in the drive shaft 10. The axially displaceable mounting of the adjusting element 31 with respect to the drive shaft 10 is sealed off in relation to the comminution hollow chamber 4.

For the purposes of sealing off, the comminution apparatus 1 has a sealing arrangement 90 comprising a sealing fluid pump apparatus 92, which has a pump inlet 92a and a pump outlet 92b, and a sealing chamber 91, which is connected to the pump outlet 92b, is adjacent to the comminution hollow chamber 4, has a fluid pressure applied to it via the pump outlet 92b, which fluid pressure results from the fluid pressure difference generated by the sealing fluid pump apparatus 92, and by means of this fluid pressure seals off the comminution hollow chamber 4 against the egress of solids-containing medium from the comminution hollow chamber 4 along the drive shaft 10. Preferably, the sealing chamber pressure is set depending on the hollow chamber pressure in the comminution hollow chamber 4. In this preferred embodiment, it is provided that the sealing chamber 91 pressure is at least 0.5 bar greater than the hollow chamber pressure. The pump inlet 92a may be fluidically connected to a fluid tank 93.

FIG. 2a is a schematic illustration of the sealing arrangement 90 shown in FIG. 2. This illustration demonstrates that the pump outlet 92b is fluidically connected to the sealing chamber 91 via a corresponding hydraulics line. The pump inlet 92a of the sealing fluid pump apparatus 92 is fluidically connected to the fluid tank 93 via a corresponding hydraulics line. In order to generate the desired fluid pressure for the desired sealing-off, the sealing fluid pump apparatus 92 delivers a correspondingly required amount of fluid from the fluid tank 93 to the sealing chamber 91.

To monitor the actual state or actual characteristics of operating parameters of the comminution apparatus 1, the comminution apparatus 1 has a detection apparatus 60. The detection apparatus 60 is designed, for instance with a view to the adjustability of the first cutting elements 21 with respect to the second cutting element 22, to measure a contact pressure of the first cutting element 21 against the second cutting element 22 and/or to detect an arrangement of the first cutting element 21 and the second cutting element 22 relative to one another. In particular, the detection apparatus 60 is designed to detect a lifting-off of the first cutting element 21 and the second cutting element 22 from one another. Therefore, the detection apparatus 60 is designed to measure an actual characteristic of the operating parameter of contact pressure, and/or an actual characteristic of the operating parameter of distance between cutting edges. To this end, the detection apparatus 60 may comprise a pressure sensor (not illustrated) for measuring the contact pressure and/or one or more hollow chamber pressure sensors 62 for measuring a hollow chamber pressure in the comminution hollow chamber 4 and/or a distance sensor (not illustrated) for measuring the distance between cutting edges.

Furthermore, in this preferred embodiment it is provided that the comminution apparatus 1 comprises further sensors for measuring actual characteristics of the comminution apparatus 1. These include, inter alia, a rotational speed sensor, which is designed to measure the rotational speed of the drive shaft 10 and/or of the first cutting elements 21, and/or a volumetric flow rate sensor, which is designed to measure the volumetric flow rate of the solids-containing medium that is to be comminuted and/or has been comminuted.

In particular in order to ensure reliable operation and low maintenance and upkeep costs, it is also provided that the detection apparatus 60, for example, has a pressure loss sensor for measuring a pressure loss in the comminution apparatus 1 and/or a fill level monitoring sensor 63 for measuring the fill level of the solids-containing medium in the comminution apparatus 1, and/or a vibration sensor 61 for detecting vibration of the comminution apparatus 1. These additional sensors make it possible to reliably detect for instance seal damage, dry running, or foreign bodies in the comminution apparatus 1, with the result that maintenance can be carried out on the comminution apparatus 1 in good time so that a high degree of consequential damage is minimized.

In this preferred embodiment, the control apparatus 80 of the comminution apparatus 1 has a memory unit on which the different operating modes for operating the comminution apparatus 1 with different comminution performances are stored. It is also provided that the operating modes of the comminution apparatus 1 can be set on the control apparatus 80. In particular, the target characteristics of the operating parameters can be established for the individual operating modes. To this end, it is provided that the comminution apparatus 1 has an input apparatus 70, which is designed for selection and input of the operating mode and of the target characteristics of the operating parameters for the respective operating mode. The input apparatus 70 is coupled in signalling terms to the control apparatus 80 for this purpose.

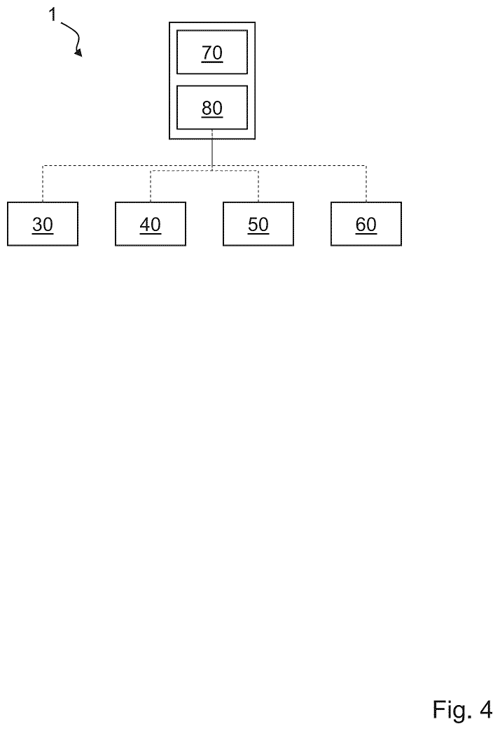

In order to correspondingly control or regulate the comminution apparatus 1 depending on the selected operating mode, it is also provided that the control apparatus is coupled in signalling terms to the adjusting apparatus 30, the drive apparatus 40, the pumping apparatus 50, and the detection apparatus 60—this is illustrated schematically in FIG. 4. In this respect, the control apparatus 80 is designed to measure the actual characteristics of the operating parameters, to compare the actual characteristics of the operating parameters with the target characteristics of the operating parameters, to set the target characteristics of the operating parameters depending on the operating mode, and to set the characteristics of the operating parameters depending on the comparison of the actual characteristics of the operating parameters with the target characteristics of the operating parameters. Correspondingly, the control apparatus 80 is also designed to carry out the steps of the method described below.

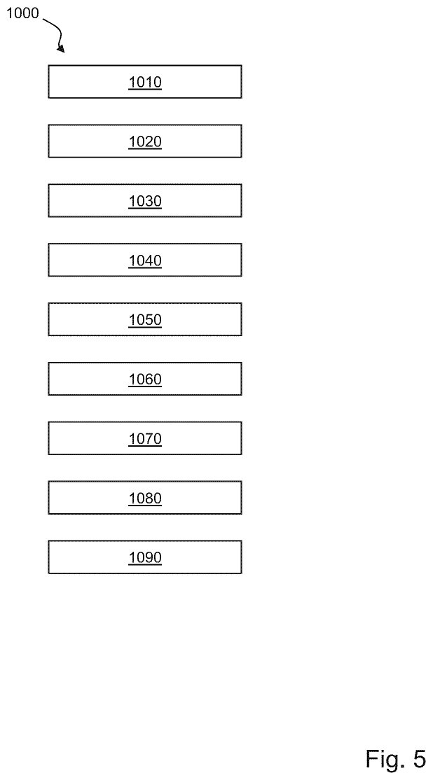

FIG. 5 shows a schematic block diagram of a method 1000 for controlling a comminution apparatus 1 in a preferred embodiment to comminute a solids-containing medium with a variable comminution performance. The comminution apparatus 1 is, for example, designed as described above. The method 1000 firstly comprises a step of starting 1010 the comminution apparatus 1, so that in a next step an operating mode can be selected 1020 from a list of operating modes, wherein the list of operating modes comprises a first operating mode and at least one second operating mode different from the first operating mode. In a further step 1030, comminuting of the solids-containing medium by means of the comminution apparatus 1 depending on the selected operating mode is provided.

It may also be preferred for the method 1000 to comprise a step of determining 1040 a target characteristic of at least one operating parameter for the first operating mode and/or for the at least one second operating mode, wherein the first operating mode and the at least one second operating mode differ in terms of a target characteristic of at least one operating parameter. Furthermore, the method can preferably include the further steps of setting 1050 a target characteristic of at least one operating parameter of the at least one operating parameter depending on the selected operating mode, and operating 1060 the comminution apparatus 1 depending on the target characteristic of the at least one operating parameter. In particular, according to the method, what is provided is a step of measuring 1070 an actual characteristic of the at least one operating parameter, a step of comparing 1080 the measured actual characteristic with a target characteristic of the at least one operating parameter, and/or a step of adapting 1090 the characteristic of the at least one operating parameter until the target characteristic of the at least one operating parameter is reached.

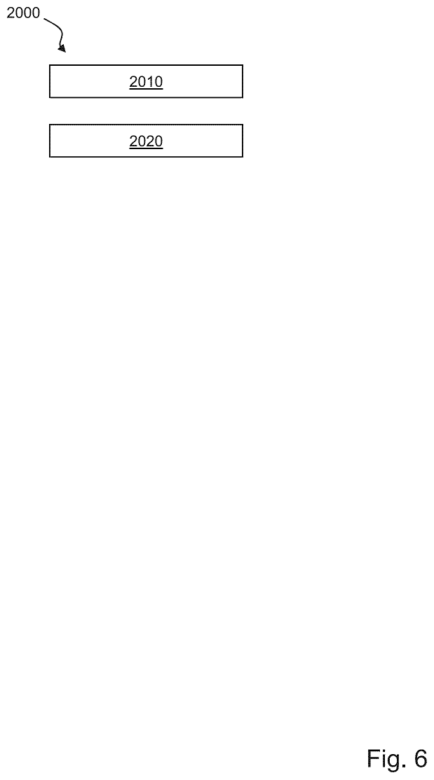

FIG. 6 shows a schematic block diagram of a further method 2000 for controlling a comminution apparatus 1 in a preferred embodiment to comminute a solids-containing medium with a variable comminution performance. The comminution apparatus 1 is, for example, designed as described above. The method 2000 comprises a step of minimizing 2010 a contact pressure by means of an adjusting apparatus 30 until the lifting-off of an at least one first cutting edge and an at least one second cutting edge from one another is detected, and holding 2020 the at least one first cutting edge and the at least one second cutting edge in a position from one another in which the contact pressure is minimal.

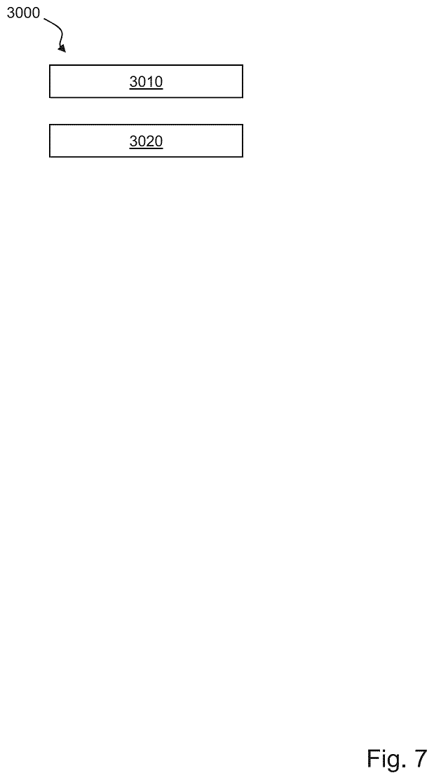

FIG. 7 shows a schematic block diagram of a further method 3000 for controlling a comminution apparatus 1 in a preferred embodiment to seal off the comminution apparatus 1 during the comminution of a solids-containing medium. The comminution apparatus 1 is, for example, designed as described above. The method 3000 comprises a step of determining 3010 a hollow chamber pressure within the comminution hollow chamber 4 by means of a pressure sensor, and a step of setting 3020 a sealing chamber pressure within the sealing chamber above the hollow chamber pressure, in particular at least 0.5 bar above the hollow chamber pressure, by means of a sealing fluid pump apparatus.

1-25. (canceled)

26. A comminution apparatus for comminuting a solids-containing medium with a variable comminution performance, the comminution apparatus comprising:
a rotatably mounted drive shaft, which can be coupled to a drive apparatus to drive a cutting apparatus, the cutting apparatus having:
a first cutting element, comprising at least one first cutting edge; and
a second cutting element, comprising at least one second cutting edge;
wherein the first cutting element and the second cutting element are movable relative to one another such that a relative movement of the first cutting element and of the second cutting element brings about a shearing action between the at least one first cutting edge and the at least one second cutting edge; and
wherein the first cutting element is connected fixedly in terms of torque to the drive shaft and is movable on a first movement path relative to the second cutting element; and
wherein the comminution apparatus is adapted for operation in a first operating mode and at least in a second operating mode different from the first operating mode to comminute the solids-containing medium, wherein the comminution apparatus can be set between the first operating mode and the at least second operating mode by means of a control apparatus to comminute the solids-containing medium.

27. A comminution apparatus for comminuting a solids-containing medium with a variable comminution performance, the comminution apparatus comprising:
a rotatably mounted drive shaft, which can be coupled to a drive apparatus to drive the comminution apparatus; and
a cutting apparatus having:
a first cutting element, comprising at least one first cutting edge; and
a second cutting element, comprising at least one second cutting edge;
wherein the first cutting element and the second cutting element are movable relative to one another in such a way that the relative movement brings about a shearing action between the at least one first cutting edge and the at least one second cutting edge; and
wherein the at least first cutting element is connected fixedly in terms of torque to the drive shaft and is movable on a first movement path relative to the second cutting element; and
wherein the at least first cutting element and the second cutting element are movable in translation relative to one another on a second movement path;
wherein a detection apparatus is provided and designed to measure a contact pressure of the first cutting element against the second cutting element and/or to detect an arrangement of the first cutting element and the second cutting element relative to one another; and
wherein an adjusting apparatus is provided and designed to displace the first cutting element and the second cutting element relative to one another on a second movement path to set the distance between cutting edges, until a desired contact pressure and/or distance between the first cutting element and the second cutting element is set.

28. A comminution apparatus for comminuting a solids-containing medium with a variable comminution performance, the comminution apparatus comprising:
a rotatably mounted drive shaft, which can be coupled to a drive apparatus to drive the comminution apparatus; and
a cutting apparatus having:
a first cutting element, comprising at least one first cutting edge; and
a second cutting element, comprising at least one second cutting edge;
wherein the first cutting element and the second cutting element are movable relative to one another such that the relative movement brings about a shearing action between the at least one first cutting edge and the at least one second cutting edge; and
wherein the at least first cutting element is connected fixedly in terms of torque to the drive shaft and is movable on a first movement path relative to the second cutting element; and
wherein the cutting apparatus is disposed within a comminution hollow chamber between an opening outlet, through which the comminuted solids-containing medium can flow out of the comminution hollow chamber, and an opening inlet, through which the solids-containing medium that is to be comminuted can flow into the comminution hollow chamber;
wherein the comminution apparatus has a sealing arrangement comprising a sealing fluid pump apparatus, which has a pump inlet and a pump outlet, and a sealing chamber which is connected to the pump outlet, is adjacent to the comminution hollow chamber, has a fluid pressure applied to it via the pump outlet, which fluid pressure results from the fluid pressure difference generated by the sealing fluid pump apparatus, and by means of this fluid pressure seals off the comminution hollow chamber against the egress of solids-containing medium from the comminution hollow chamber along the drive shaft.

29. The comminution apparatus according to claim 28, wherein a sealing chamber pressure within the sealing chamber is greater than the hollow chamber pressure within the comminution hollow chamber, and wherein the sealing chamber pressure is at least 0.5 bar greater than the hollow chamber pressure.

30. The comminution apparatus according to claim 27, wherein the comminution apparatus is adapted for operation in a first operating mode and at least in a second operating mode different from the first operating mode, wherein the comminution apparatus can be set between the first operating mode and the at least second operating mode.

31. The comminution apparatus according to claim 26, wherein:
the comminution of the solids-containing medium during operation of the comminution apparatus in the first operating mode and at least in the second operating mode different from the first operating mode depends on one or more of the following operating parameters:
a rotational speed of the first cutting element;
a contact pressure between the first cutting element and the second cutting element;
a cutting edge distance between the at least one first cutting edge and the at least one second cutting edge;
a volumetric flow rate of the solids-containing medium through the cutting apparatus;
a hollow chamber inlet pressure upstream of the cutting apparatus in the region of an opening inlet;
a hollow chamber outlet pressure downstream of the cutting apparatus in the region of an opening outlet; and/or
a hollow chamber differential pressure, which corresponds to the difference between the hollow chamber inlet pressure and the hollow chamber outlet pressure;
wherein the first operating mode and the at least second operating mode differ in terms of a target characteristic of at least one operating parameter of the at least one operating parameter.

32. The comminution apparatus according to claim 31, wherein:
a first selection of the operating parameters from the at least one operating parameter in the first operating mode comprises or can comprise target characteristics which are smaller than the target characteristics of the corresponding operating parameters in the at least second operating mode;
a second selection of the operating parameters from the at least one operating parameter in the first operating mode comprises or can comprise target characteristics which are larger than the target characteristics of the corresponding operating parameters in the at least second operating mode; and/or
a third selection of the operating parameters from the at least one operating parameter in the first operating mode comprises or can comprise target characteristics which correspond to the target characteristics of the corresponding operating parameters in the at least second operating mode.

33. The comminution apparatus according to claim 26, having an adjusting apparatus, which is designed to displace the at least first cutting element and the at least second cutting element relative to one another on a second movement path to set the distance between cutting edges, and/or is designed to transfer a force along the second movement path to set the contact pressure.

34. The comminution apparatus according to claim 33, wherein the adjusting apparatus is or comprises an electrically actuable adjusting apparatus, a hydraulically actuable adjusting apparatus, and/or a mechanically actuable adjusting apparatus.

35. The comminution apparatus according to claim 34, wherein the electrically actuable adjusting apparatus is or comprises an electric linear drive.

36. The comminution apparatus according to claim 26, wherein the second cutting element is a perforated disc and a plurality of second cutting edges are formed by openings in walls delimiting the perforated disc.

37. The comminution apparatus according to claim 36, wherein the first cutting element comprises a blade which is disposed rotatably along the first movement path, wherein the blade is preferably disposed rotatably on a surface of the perforated disc.

38. The comminution apparatus according to claim 26, having an opening inlet, through which the solids-containing medium that is to be comminuted can enter the comminution apparatus during operation, and an opening outlet, through which the comminuted solids-containing medium can leave the comminution apparatus during operation, wherein a comminution hollow chamber fluidically connects the opening outlet, which is downstream in the conveying direction of the solids-containing medium, to the opening inlet.

39. The comminution apparatus according to claim 38, wherein the cutting apparatus is disposed within the comminution hollow chamber between the opening outlet and the opening inlet.

40. The comminution apparatus according to claim 26, having a pumping apparatus for delivering the solids-containing medium through the cutting apparatus at the volumetric flow rate.

41. The comminution apparatus according to claim 40, wherein the pumping apparatus is or comprises an adjustable pump for setting the volumetric flow rate of the solids-containing medium.

42. The comminution apparatus according to claim 31, having a detection apparatus, which is designed to measure actual characteristics of the operating parameters and/or to measure the distance between cutting edges;
wherein the detection apparatus comprises:
a rotational speed sensor for measuring the rotational speed of the drive shaft and/or of the first cutting element;
a pressure loss sensor for measuring a pressure loss;
a fill level monitoring sensor for measuring the fill level of the solids-containing medium in the comminution apparatus;
a vibration sensor for detecting vibration of the comminution apparatus;
a volumetric flow rate sensor for measuring the volumetric flow rate of the solids-containing medium;
a pressure sensor for measuring the contact pressure;
one or more hollow chamber pressure sensors for measuring a hollow chamber pressure in the comminution hollow chamber; and/or
a distance sensor for measuring the distance between cutting edges.

43. The comminution apparatus according to claim 31, having:
an input apparatus adapted for selection and/or input of the operating mode and/or the target characteristics of the operating parameters for the respective operating mode;
the drive apparatus operably coupled fixedly in terms of torque to the drive shaft and/or the cutting apparatus to drive the cutting apparatus;
the control apparatus, which can be or is coupled to the adjusting apparatus, the drive apparatus, the pumping apparatus, the detection apparatus, and/or the input apparatus in signalling terms, and which is adapted to:
record the actual characteristics of the operating parameters;
compare the actual characteristics of the operating parameters with the target characteristics of the operating parameters;
set the target characteristic of the operating parameters depending on the operating mode; and/or
set the characteristics of the operating parameters depending on the comparison between the actual characteristics of the operating parameters and the target characteristics of the operating parameters.

44. A method for controlling a comminution apparatus, in particular a comminution apparatus according to claim 26, to comminute a solids-containing medium with a variable comminution performance, the method comprising the following step:
starting the comminution apparatus; and
comprising the following steps:
selecting an operating mode from a list of operating modes, wherein the list of operating modes includes the first operating mode and the at least a second operating mode different from the first operating mode; and
comminuting the solids-containing medium by means of the comminution apparatus depending on the selected operating mode.

45. The method according to claim 44, comprising the following step:
determining a target characteristic of at least one operating parameter for the first operating mode and/or for the at least one second operating mode, wherein the first operating mode and the at least one second operating mode differ in terms of a target characteristic of at least one operating parameter.

46. The method according to claim 45, comprising the following steps:
setting a target characteristic of at least one operating parameter of the at least one operating parameter depending on the selected operating mode; and
operating the comminution apparatus depending on the target characteristic of the at least one operating parameter.

47. The method according to claim 45, comprising the following step(s):
recording an actual characteristic of the at least one operating parameter;
comparing the recorded actual characteristic with the target characteristic of the at least one operating parameter; and/or
adapting the characteristic of the at least one operating parameter until the target characteristic of the at least one operating parameter is reached.

48. The method for controlling the comminution apparatus according to claim 26, to comminute a solids-containing medium with a variable comminution performance, the method comprising the following steps:
minimizing a contact pressure by means of an adjusting apparatus until a lifting-off of the at least one first cutting edge and the at least one second cutting edge from one another is detected; and
holding the at least one first cutting edge and the at least one second cutting edge in a position from one another in which the contact pressure is minimal.

49. The method for controlling a comminution apparatus, in particular a comminution apparatus according to claim 26, to seal off the comminution apparatus during the comminution of a solids-containing medium, the method comprising the following steps:
determining a hollow chamber pressure within a comminution hollow chamber by means of a pressure sensor; and
setting a sealing chamber pressure within the sealing chamber above the hollow chamber pressure by at least 0.5 bar above the hollow chamber pressure by use of a sealing fluid pump apparatus.

50. A control apparatus for controlling the comminution apparatus a comminution apparatus according to claim 27, to comminute a solids-containing medium with a variable comminution performance, wherein the control apparatus is adapted to:
starting the comminution apparatus; and
comprising the following steps:
selecting an operating mode from a list of operating modes, wherein the list of operating modes includes the first operating mode and the at least a second operating mode different from the first operating mode; and
comminuting the solids-containing medium by means of the comminution apparatus depending on the selected operating mode.
